(19) United States
(12) Patent Application Publication
(10) Pub. No.: US 2025/0320320 A1
(43) Pub. Date: Oct. 16, 2025

(54) METALLOCENE COMPLEX AND PREPARATION METHOD THEREFOR, CATALYST COMPOSITION, OLEFIN POLYMERIZATION METHOD AND OLEFIN POLYMER

(71) Applicants: CHINA PETROLEUM & CHEMICAL CORPORATION, Beijing (CN); SINOPEC (BEIJING) RESEARCH INSTITUTE OF CHEMICAL INDUSTRY CO., LTD., Beijing (CN)

(72) Inventors: Nian GAO, Beijing (CN); Jianjun CHEN, Beijing (CN); Ning WU, Beijing (CN); Jianguo HAO, Beijing (CN); Hongbo LI, Beijing (CN); Lin XU, Beijing (CN)

(21) Appl. No.: 18/869,883

(22) PCT Filed: Nov. 14, 2022
(86) PCT No.: PCT/CN2022/131728

§ 371 Date: Nov. 27, 2024

(30) Foreign Application Priority Data
May 27, 2022 (CN) 202210586608.1

(51) Int. Cl. C08F 36/06

(52) U.S. Cl. CPC C08F 36/06; C08F 2420/07

(57) ABSTRACT

A metallocene complex and a preparation method therefor, a catalyst composition, an olefin polymerization method and an olefin polymer are provided. The metallocene complex has a structure of formula I. The catalyst composition containing the metallocene complex shows an improved catalytic activity, and also has relatively high structural regularity control capability for a conjugated diene structural unit and a relatively high capability for copolymerizing ethylene and conjugated diene.

### CROSS REFERENCE TO RELATED APPLICATIONS

This application claims the benefit of Chinese patent application 202210586608.1, filed on May 27, 2022, the contents of which are incorporated herein by reference.

### FIELD OF THE INVENTION

The present invention relates to a metallocene complex and a preparation method therefor. The present invention also relates to a catalyst composition containing the metallocene complex. The present invention further relates to an olefin polymerization method using the catalyst composition and an olefin polymer prepared by the method.

### BACKGROUND OF THE INVENTION

Metallocene complexes refer to compounds in which a central metal is coordinated with one or more cyclopentadienyl or a derivative thereof, and play a very important role as a catalyst in various polymerization reactions. The metallocene complexes exhibit different catalytic properties in polymerization reactions due to different types of ligands and central metals.

There have been many suggestions for polymerization catalysts for the polymerization of conjugated dienes. For example, it is known to obtain high cis-1,4-conjugated diene polymers by using a composite catalyst system containing a neodymium compound and an organoaluminum compound as main components. Some of these composite catalyst system have been used industrially as polymer catalyst systems for butadiene. However, there has always been a need for a method for efficiently manufacturing a conjugated diene polymer having a high content of cis-1,4-structure in a microstructure, a high molecular weight, and a narrow molecular weight distribution. Therefore, it is necessary to develop a polymerization catalyst.

As a widely used and easily available monomer, ethylene is widely used in the plastics industry. Conjugated dienes, particularly butadiene and isoprene, are the most important monomers for the synthesis of rubbers. Butadiene, as a by-product in the process of preparing ethylene by a petroleum route, was once similar in price to ethylene. Due to the change in the ethylene preparation route, the production of butadiene is decreased, resulting in a significant increase in the price of butadiene. In contrast, the price of ethylene is reduced. Therefore, it is attractive to use ethylene as a raw material for preparing rubber for tires, and the raw material cost can be greatly saved. However, it is difficult to copolymerize conjugated dienes and α-olefins due to their different polymerization mechanisms. Thus, it is an extremely challenging task to use the same catalytic system to catalyze the copolymerization of ethylene and conjugated dienes, and realizing the copolymerization of ethylene and conjugated dienes has always been the direction of academic and industrial efforts. The development of metallocene complexes with high catalytic activity, a relatively high structural regularity control capability for a conjugated diene structural unit and a relatively high capability for copolymerizing ethylene and conjugated dienes is highly attractive.

In 2015, Michiue et al. reported a series of silicon-bridged disubstituted indenylzirconiums for the preparation of a copolymer of ethylene/propylene and butadiene in the presence of hydrogen (K. Michiue, M. Mitani, T. Fujita, Catalysts 2015, 5, 2001-2017). The catalyst has higher activity and can result in polymers with a higher molecular weight. As the steric hindrance of substituents on indene increases, the vinyl content of the copolymer increases. However, the insertion rate of butadiene in the obtained copolymer is low, and the copolymer contains cyclopropyl and cyclopentyl structures. Rare earth catalysts have also been attempted for the copolymerization of ethylene and conjugated dienes due to their better affinity for conjugated dienes. Boisson et al. reported a series of dicyclopentadienylneodymium catalysts that can efficiently catalyze the copolymerization of ethylene and butadiene (M. Llauro, C. Monnet, F. Barbotin, V. Monteil, R. Spitz, C. Boisson, Macromolecules 2001, 34, 6304-6311; H. Nsiri, I. Belaid, P. Larini, J. Thuilliez, C. Boisson, L. Perrin, ACS Catal. 2016, 6, 1028-1036). The butadiene content of the copolymer is high and butadiene mainly exists in the trans-1,4-structure. The molecular weight of the polymer is not high enough and the polymer contains a cyclohexyl structure.

Transition metal compounds having heterocyclic fused five-membered ring π ligands and use of the compounds in catalyzing the polymerization of monoolefins have been reported, and the compounds have the advantages of high activity and high molecular weight. However, there are few reports on the catalytic copolymerization of ethylene and conjugated dienes. There is no report on the research of bis(cyclopentadienyl) rare earth catalysts with heterocyclic fusion and use thereof in copolymerization of ethylene and conjugated dienes.

### SUMMARY OF THE INVENTION

An object of the present invention is to provide a catalyst composition. The catalyst composition has an improved catalytic activity and can precisely control the structure of a conjugated diene structural unit, thereby improving the structural regularity of the conjugated diene structural unit in the prepared polymer, and can effectively control the copolymerization composition of a copolymer when used in the copolymerization of ethylene and conjugated dienes.

According to a first aspect of the present invention, the present invention provides a metallocene complex, having a structure shown in a formula I,

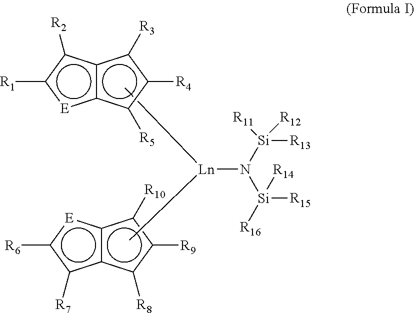

wherein in the formula I, Ln is a lanthanide, scandium, or yttrium;
R₁, R₂, R₃, R₄, R₅, R₆, R₇, R₈, R₉, and R₁₀ are the same or different, and are each independently hydrogen, C₁-C₂₀ alkyl, C₆-C₃₀ aryl or —SiR₂₃R₂₄R₂₅, and R₂₃, R₂₄, and R₂₅ are the same or different, and are each independently hydrogen or C₁-C₂₀ alkyl;
R₁₁, R₁₂, R₁₃, R₁₄, R₁₅ and R₁₆ are the same or different, and are each independently hydrogen or C₁-C₅ alkyl;
E is O, S, or N—R₁₇, and R₁₇ is C₁-C₅ alkyl or C₆-C₁₂ aryl.

According to a second aspect of the present invention, the present invention provides a method for preparing the metallocene complex according to the first aspect of the present invention, comprising the steps of:
Step 1, contacting a precursor compound with a heterocyclic compound in the presence of organolithium, wherein the heterocyclic compound is selected from a group consisting of compounds represented by a formula 2-2-1 and compounds represented by a formula 2-2-2, and
Step 2, contacting a mixture obtained in the step 1 with an amine represented by a formula 2-3, wherein
the precursor compound is selected from the group consisting of compounds represented by a formula 2-1,

LnX (Formula 2-1)
in the formula 2-1, Ln is a lanthanide, scandium, or yttrium,
X is a halogen atom, preferably chlorine;

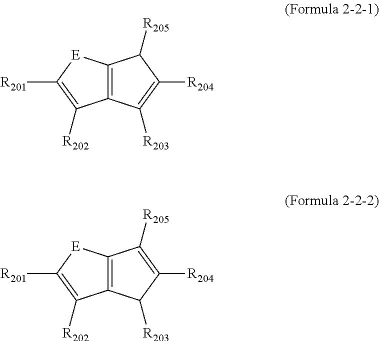

in the formula 2-2-1 and formula 2-2-2, R₂₀₁, R₂₀₂, R₂₀₃, R₂₀₄, and R₂₀₅ are the same or different, and are each independently hydrogen, C₁-C₂₀ alkyl, C₆-C₃₀ aryl or —SiR₂₃R₂₄R₂₅, and R₂₃, R₂₄, and R₂₅ are the same or different, and are each independently hydrogen or C₁-C₂₀ alkyl;
in the formula 2-2-1 and formula 2-2-2, E is O, S, or N—R₁₇, and R₁₇ is C₁-C₅ alkyl or C₆-C₁₂ aryl;

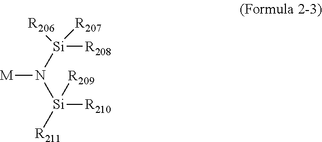

in the formula 2-3, R₂₀₆, R₂₀₇, R₂₀₈, R₂₀₉, R₂₁₀, and R₂₁₁ are the same or different, and are each independently hydrogen or C₁-C₅ alkyl,
M is an alkali metal atom, preferably potassium or sodium.

According to a third aspect of the present invention, the present invention provides a catalyst composition, including a metallocene complex and a cocatalyst, the metallocene complex being the metallocene complex according to the first aspect of the present invention.

According to a fourth aspect of the present invention, the present invention provides an olefin polymerization method, comprising contacting at least one olefin with components in a catalyst composition under olefin polymerization conditions, the catalyst composition being the catalyst composition according to the second aspect of the present invention.

According to a fifth aspect of the present invention, the present invention provides an olefin polymer prepared by the method according to the fourth aspect of the present invention.

The catalyst composition containing the metallocene complex according to the present invention exhibits an improved catalytic activity while also having a relatively high structural regularity control capability for the conjugated diene structural unit and a relatively high capability for copolymerizing ethylene and conjugated dienes. The catalyst composition comprising the metallocene complex according to the present invention can precisely control the structure of the conjugated diene structural unit, thereby improving the structural regularity of the conjugated diene structural unit in the prepared polymer. The catalyst system comprising the metallocene complex according to the present invention has good copolymerization properties, and can efficiently achieve the copolymerization of ethylene and conjugated dienes, and effectively control the copolymerization composition of the copolymer. The method for preparing the metallocene complex according to the present invention prepares the metallocene complex by a “one-pot method”, effectively simplifying the synthetic route, and reducing the operational complexity and the operational cost.

### DETAILED DESCRIPTION OF THE EMBODIMENTS

The endpoints and any values of the ranges disclosed herein are not limited to the precise range or value, and these ranges or values should be understood as including values close to these ranges or values. For numerical ranges, the endpoint values of each range, the endpoint values of each range and individual point values, and individual point values may be combined with each other to obtain one or more new numerical ranges, and these numerical ranges should be considered to be specifically disclosed herein.

According to a first aspect of the present invention, the present invention provides a metallocene complex, having a structure shown in a formula I,

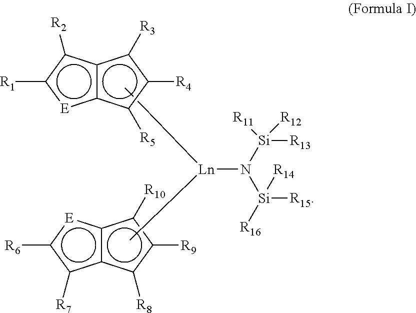

In the formula I, Ln is a lanthanide, scandium, or yttrium.

In the present invention, the term “lanthanide” refers to a collective name of 15 elements from lanthanum, element 57, to lutetium, element 71, in the periodic table of elements.

In the formula I, specific examples of Ln can include, but are not limited to, scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), or lutetium (Lu).

Preferably, in the formula I, Ln is gadolinium or scandium. More preferably, in the formula I, Ln is gadolinium.

In the formula I, R₁, R₂, R₃, R₄, R₅, R₆, R₇, R₈, R₉, and R₁₀ are the same or different, and are each independently hydrogen, C₁-C₂₀ alkyl, C₆-C₃₀ aryl or —SiR₂₃R₂₄R₂₅, and R₂₃, R₂₄, and R₂₅ are the same or different, and are each independently hydrogen or C₁-C₂₀ alkyl; and preferably, at least one of R₂₃, R₂₄, and R₂₅ is C₁-C₂₀ alkyl.

In the present invention, the C₁-C₂₀ alkyl includes C₁-C₂₀ linear alkyl, C₃-C₂₀ branched alkyl, and C₃-C₂₀ cycloalkyl, and specific examples of the C₁-C₂₀ alkyl may include, but are not limited to: methyl, ethyl, n-propyl, isopropyl, n-butyl, sec-butyl, isobutyl, tert-butyl, pentyl and its various isomers, hexyl and its various isomers, heptyl and its various isomers, octyl and its various isomers, nonyl and its various isomers, decyl and its various isomers, undecyl and its various isomers, dodecyl and its various isomers, tridecyl and its various isomers, tetradecyl and its various isomers, pentadecyl and its various isomers, hexadecyl and its various isomers, heptadecyl and its various isomers, octadecyl and its various isomers, nonadecyl and its various isomers, eicosyl and its various isomers, cyclopropyl, cyclobutyl, cyclopentyl and cyclohexyl.

In the present invention, specific examples of the C₆-C₃₀ aryl may include, but are not limited to, phenyl, tolyl, ethylphenyl, propylphenyl (wherein propyl may be n-propyl or isopropyl), butylphenyl (wherein butyl may be n-butyl, sec-butyl, isobutyl or tert-butyl), naphthyl, anthryl or phenanthryl. In a preferred embodiment, in the formula I, R₁ and R₆ are each independently C₁-C₅ alkyl, R₂, R₄, R₇ and R₉ are each independently C₆-C₁₂ aryl, and R₃, R₅, R₈ and R₁₀ are all hydrogen. In this preferred embodiment, R₁ and R₆ are preferably methyl and R₂, R₄, R₇ and R₉ are preferably phenyl. In this preferred embodiment, Ln is preferably gadolinium.

In another preferred embodiment, in the formula I, R₁, R₄, R₆ and R₉ are each independently C₁-C₂₀ alkyl, R₂ and R₇ are each independently C₆-C₃₀ aryl, and R₃, R₅, R₈ and R₁₀ are all hydrogen. In this preferred embodiment, R₁, R₄, R₆ and R₉ are each independently preferably C₁-C₅ alkyl, and R₂ and R₇ are each independently preferably C₆-C₁₂ aryl. More preferably, R₁, R₄, R₆ and R₉ are methyl or isopropyl and R₂ and R₇ are phenyl. Further preferably, R₁ and R₆ are methyl, R₄ and R₉ are methyl or isopropyl, and R₂ and R₇ are phenyl. In this preferred embodiment, Ln is preferably gadolinium. In yet another preferred embodiment, in the formula I, R₁, R₄, R₆ and R₉ are each independently C₁-C₂₀ alkyl, R₂ and R₇ are each independently C₆-C₃₀ aryl, R₅ and R₁₀ are both hydrogen, R₃ and R₈ are each independently —SiR₂₃R₂₄R₂₅, and R₂₃, R₂₄ and R₂₅ are the same or different, and are each independently C₁-C₂₀ alkyl. In this preferred embodiment, R₁, R₄, R₆ and R₉ are each independently preferably C₁-C₅ alkyl, R₂ and R₇ are each independently preferably C₆-C₁₂ aryl, R₃ and R₈ are each independently preferably —SiR₂₃R₂₄R₂₅, R₂₃, R₂₄ and R₂₅ are the same or different, and are each independently hydrogen or C₁-C₅ alkyl, and at least one of R₂₃, R₂₄ and R₂₅ is C₁-C₅ alkyl. In this preferred embodiment, R₁, R₄, R₆ and R₉ are more preferably methyl, R₂ and R₇ are more preferably phenyl, R₃ and R₈ are each independently more preferably —SiR₂₃R₂₄R₂₅, and R₂₃, R₂₄ and R₂₅ are all methyl. In this preferred embodiment, Ln is preferably gadolinium.

In the formula I, R₁₁, R₁₂, R₁₃, R₁₄, R₁₅ and R₁₆ are the same or different, and are each independently hydrogen or C₁-C₅ alkyl. Preferably, in the formula I, R₁₁, R₁₂, R₁₃, R₁₄, R₁₅ and R₁₆ are the same or different, and are each independently hydrogen or C₁-C₅ alkyl, and at least one of R₁₁, R₁₂ and R₁₃ is C₁-C₅ alkyl, and at least one of R₁₄, R₁₅ and R₁₆ is C₁-C₅ alkyl. More preferably, in the formula I, R₁₁, R₁₂, R₁₃, R₁₄, R₁₅ and R₁₆ are the same or different, and are each independently hydrogen or C₁-C₅ alkyl, and at least two of R₁₁, R₁₂ and R₁₃ are C₁-C₅ alkyl, and at least two of R₁₄, R₁₅ and R₁₆ are C₁-C₅ alkyl. Further preferably, in the formula I, Rn, R₁₂, R₁₃, R₁₄, R₁₅ and R₁₆ are the same or different, and are each independently C₁-C₅ alkyl. Still further preferably, in the formula I, Rn, R₁₂, R₁₃, R₁₄, R₁₅ and R₁₆ are all methyl.

In the formula I, E is O, S, or N—R₁₇, and R₁₇ is C₁-C₅ alkyl or C₆-C₁₂ aryl. Preferably, in the formula I, E is S.

According to the metallocene complex of the present invention, the metallocene complex is preferably a complex shown in a formula II, a formula III, a formula IV or a formula V,

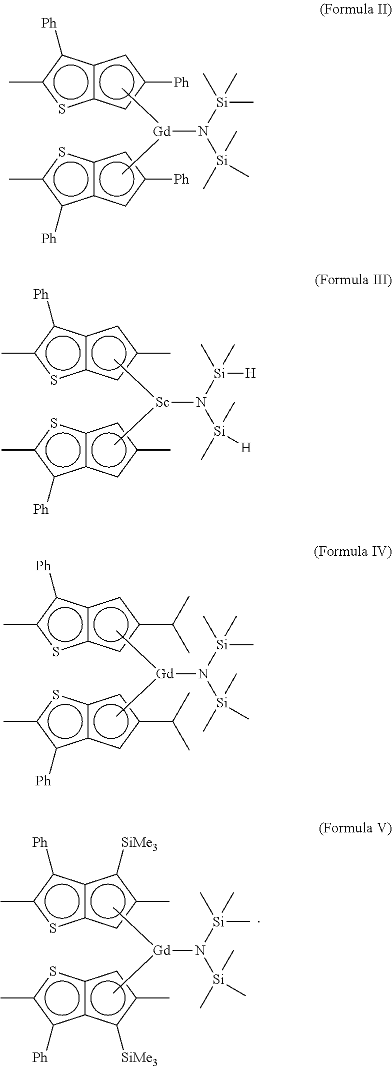

According to the metallocene complex of the present invention, the metallocene complex is particularly preferably the complex shown in the formula II, the formula IV or the formula V.

According to a second aspect of the present invention, the present invention provides a method for preparing the metallocene complex according to the first aspect of the present invention, comprising the steps of:
Step 1, contacting a precursor compound with a heterocyclic compound in the presence of organolithium, wherein the heterocyclic compound is selected from the group consisting of compounds represented by a formula 2-2-1 and compounds represented by a formula 2-2-2, and
Step 2, contacting a mixture obtained in the step 1 with an amine represented by a formula 2-3, wherein
the precursor compound is selected from the group consisting of compounds represented by a formula 2-1,

LnX (Formula 2-1)
in the formula 2-1, Ln is a lanthanide, scandium, or yttrium, preferably gadolinium or scandium, more preferably gadolinium;
X is a halogen atom which may be, for example, fluorine, chlorine, bromine or iodine, preferably chlorine;

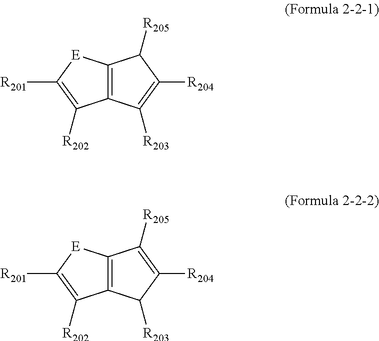

in the formula 2-2-1 and formula 2-2-2, R₂₀₁, R₂₀₂, R₂₀₃, R₂₀₄, and R₂₀₅ are the same or different, and are each independently hydrogen, C₁-C₂₀ alkyl, C₆-C₃₀ aryl or —SiR₂₃R₂₄R₂₅, and R₂₃, R₂₄, and R₂₅ are the same or different, and are each independently hydrogen or C₁-C₂₀ alkyl;
in the formula 2-2-1 and formula 2-2-2, E is O, S, or N—R₁₇, and R₁₇ is C₁-C₅ alkyl or C₆-C₁₂ aryl, preferably S;

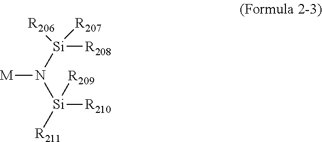

in the formula 2-3, R₂₀₆, R₂₀₇, R₂₀₈, R₂₀₉, R₂₁₀, and R₂₁₁ are the same or different, and are each independently hydrogen or C₁-C₅ alkyl,
M is an alkali metal atom, and may be, for example, lithium, sodium or potassium, preferably sodium or potassium, more preferably potassium.

According to the preparation method of the present invention, the mixture obtained in the step 1 is directly used as a raw material in the step 2 without separation to be in contact with the amine for a reaction. Separation of the mixture obtained in the step 1 is omitted. Separation not only increases the complexity and cost of operation, but also adversely affects the yield of a target product due to the loss of materials in the separation process. According to the preparation method of the present invention, the mixture obtained in the step 1 is directly used in the step 2 without separation, not only simplifying the operation, reducing the cost, but also not adversely affecting the yield of the target product.

According to the preparation method of the present invention, in the formula 2-2-1 and the formula 2-2-2, R₂₀₁, R₂₀₂, R₂₀₃, R₂₀₄, and R₂₀₅ correspond to R₁, R₂, R₃, R₄, R₅, R₆, R₇, R₈, R₉, and R₁₀ in the compound shown in the formula I, and specific examples thereof are given so that the compound shown in the formula I can be obtained, which will not be described in detail here.

According to the preparation method of the present invention, in the formula 2-3, R₂₀₆, R₂₀₇, R₂₀₈, R₂₀₉, R₂₁₀, and R₂₁₁ correspond to R₁₁, R₁₂, R₁₃, R₁₄, R₁₅ and R₁₆ in the compound shown in the formula I, and specific examples thereof are given so that the compound shown in the formula I can be obtained, which will not be described in detail here.

According to the preparation method of the present invention, in the step 1, the precursor compound is contacted with the heterocyclic compound in the presence of the organolithium, the organolithium being preferably an organomonolithium compound, more preferably a compound shown in a formula VIII,

R₂₆Li (Formula VIII)

in the formula VIII, R₂₆ is C₁-C₁₀ alkyl, such as methyl, ethyl, n-propyl, isopropyl, n-butyl, sec-butyl, isobutyl, tert-butyl, n-pentyl, isopentyl, tert-pentyl, neopentyl, hexyl (including various isomers of hexyl), heptyl (including various isomers of heptyl), octyl (including various isomers of octyl), nonyl (including various isomers of nonyl), or decyl (including various isomers of decyl).

Specific examples of the organolithium may include, but are not limited to, one or two or more of ethyllithium, n-propyllithium, isopropyllithium, n-butyllithium, sec-butyllithium, tert-butyllithium, and isobutyllithium.

Preferably, the organolithium is one or two or more selected from the group consisting of n-butyllithium, sec-butyllithium, isobutyllithium and tert-butyllithium. More preferably, the organolithium is n-butyllithium.

In the step 1, contacting the precursor compound with the heterocyclic compound may be performed at a temperature of 0-65° C. and a duration of the contacting may be 1-120 h, preferably 1.2-80 h, more preferably 1.5-40 h, further preferably 2-10 h. In the step 1, the precursor compound is contacted with a lithium salt of the heterocyclic compound in a first solvent, the first solvent being preferably one or two or more of tetrahydrofuran, diethyl ether, dioxane, and hexane. The precursor compound and the heterocyclic compound may be separately mixed with a portion of the first solvent to form solutions, and the solution containing the precursor compound may be mixed with the solution containing the heterocyclic compound, thereby contacting the precursor compound with the lithium salt of the heterocyclic compound.

In the step 1, the organolithium is preferably contacted with the heterocyclic compound to form a lithium salt and then the lithium salt is contacted with the precursor compound, the lithium salt having a structure shown in a formula 2-4.

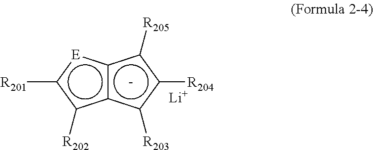

The heterocyclic compound may be dissolved in the first solvent to be placed in an environment of −78° C. to 0° C., followed by addition of alkyl lithium for a reaction. The heterocyclic compound reacts with the alkyl lithium at a temperature of preferably −78° C. to 60° C., more preferably −50° C. to 50° C., further preferably −10° C. to 30° C.; and the reaction time is preferably 0.8-10 h, more preferably 0.8-8 h, further preferably 1-5 h.

According to the preparation method of the present invention, the mixture formed after contacting the precursor compound with the heterocyclic compound in the step 1 is directly contacted with the amine in the step 2 without separation to obtain the metallocene complex according to the present invention. According to the preparation method of the present invention, in the step 2, the mixture obtained in the step 1 is contacted with the amine, preferably in a second solvent, the second solvent being preferably one or two or more of toluene, xylene and chlorobenzene. Preferably, at least part of the first solvent is removed from the mixture obtained after the contacting in the step 1 to obtain a mixture with at least part of the first solvent removed, and the mixture with at least part of the first solvent removed is mixed with the second solvent such that the contacting in the step 2 is performed in the second solvent.

According to the preparation method of the present invention, in the step 2, the mixture obtained in the step 1 may be contacted with the amine at a temperature of 0-30° C. and a duration of the contacting may be 1-48 h.

According to the preparation method of the present invention, the metallocene complex according to the present invention may be separated from a mixture obtained in the step 2 by conventional methods. In a preferred embodiment, at least part of the second solvent can be removed from the reaction mixture obtained in the step 2, a third solvent is added to the reaction mixture with at least part of the second solvent removed, followed by solid-liquid separation, a liquid-phase material is collected, a solvent is removed from the liquid-phase material, and a residual solid-phase material is the metallocene complex according to the present invention. The third solvent may be one or two or more of hexane, heptane, and toluene.

According to a third aspect of the present invention, the present invention provides a catalyst composition, comprising a metallocene complex and a cocatalyst, the metallocene complex being the metallocene complex according to the first aspect of the present invention.

According to the catalyst composition of the present invention, the cocatalyst may be a cocatalyst commonly used in the field of olefin polymerization. In a preferred embodiment, the cocatalyst is an organoaluminum compound and/or an organoboron compound.

The organoaluminum compound is preferably alumoxane and/or a compound represented by a formula V,

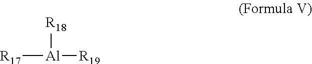

in the formula V, R₁₇, R₁₅, and R₁ are the same or different, and are each independently selected from hydrogen, C₁-C₁₀ alkyl, C₁-C₁₀ alkoxy, C₆-C₂₀ aryl, C₇-C₁₅ alkaryl, C₇-C₁₅ aralkyl, and a hydrogen atom, and R₁₇, R₁₅, and R₁ are not simultaneously a hydrogen atom.

The C₁-C₁₀ alkyl includes C₁-C₁₀ linear alkyl, C₃-C₁₀ branched alkyl, and C₃-C₁₀ cycloalkyl, and specific examples of the C₁-C₁₀ alkyl may include, but are not limited to: methyl, ethyl, n-propyl, isopropyl, n-butyl, sec-butyl, isobutyl, tert-butyl, pentyl and its various isomers, hexyl and its various isomers, heptyl and its various isomers, octyl and its various isomers, nonyl and its various isomers, decyl and its various isomers, cyclopropyl, cyclobutyl, cyclopentyl and cyclohexyl. Specific examples of the C₁-C₁₀ alkoxy may include, but are not limited to, methoxy, ethoxy, propoxy, and butoxy.

Specific examples of the C₆-C₂₀ aryl may include, but are not limited to, phenyl, tolyl, ethylphenyl, propylphenyl (wherein propyl may be n-propyl or isopropyl), butylphenyl (wherein butyl may be n-butyl, sec-butyl, isobutyl, or tert-butyl), naphthyl, anthryl, or phenanthryl.

The alkaryl refers to aryl with an alkyl substituent, and specific examples of the alkaryl may include, but are not limited to, tolyl, ethylphenyl, dimethylphenyl, and diethylphenyl.

The aralkyl refers to alkyl with an aryl substituent, and specific examples of the aralkyl may include, but are not limited to, benzyl, phenethyl, 1-phenylpropyl, 2-phenylpropyl, and 3-phenylpropyl.

Specific examples of the organoaluminum compound may include, but are not limited to: diethylaluminum hydride, di-n-propylaluminum hydride, di-n-butylaluminum hydride, diisobutylaluminum hydride, diphenylaluminum hydride, bis(p-tolyl)aluminum hydride, dibenzylaluminum hydride, phenyl ethylaluminum hydride, phenyl n-propylaluminum hydride, p-tolyl ethylaluminum hydride, p-tolyl n-propylaluminum hydride, p-tolyl isopropylaluminum hydride, benzyl ethylaluminum hydride, benzyl n-propylaluminum hydride, benzyl isopropylaluminum hydride, ethylaluminum dihydride, butylaluminum dihydride, isobutylaluminum dihydride, octylaluminum dihydride, amylaluminum dihydride, diethylaluminum ethoxide, dipropylaluminum ethoxide, trimethylaluminum, triethylaluminum, tri-n-propylaluminum, triisopropylaluminum, tri-n-butylaluminum, triisobutylaluminum, tripentylaluminum, trihexylaluminum, tricyclohexylaluminum, trioctylaluminum, triphenylaluminum, tris(p-tolyl)aluminum, tribenzylaluminum, ethyldiphenylaluminum, ethylbis(p-tolyl)aluminum, ethylbis(benzyl)aluminum, diethylphenylaluminum, diethyl(p-tolyl)aluminum, and diethylbenzylaluminum.

In one preferred example, in the formula V, R₁₇, R₁₈, and R₁₉ are hydrogen, methyl, ethyl, n-propyl, isopropyl, n-butyl or isobutyl, and at most one of R₁₇, R₁₈, and R₁₉ is hydrogen. More preferably, in the formula V, R₁₇, R₁₈, and R₁₉ are hydrogen or butyl and at most one of R₁₇, R₁₈, and R₁₉ is hydrogen.

According to the catalyst composition of the present invention, the organoaluminum compound is preferably triisobutylaluminum and/or diisobutylaluminum hydride.

The organoboron compound is preferably an organoborate. The organoborate is an ionic compound consisting of a borate anion and a cation.

Specific examples of the borate anion may include, but are not limited to: tetraphenylborate, tetrakis(monofluorophenyl)borate, tetrakis(difluorophenyl)borate, tetrakis(trifluorophenyl)borate, tetrakis(tetrafluorophenyl)borate, tetrakis(pentafluorophenyl)borate, tetrakis(tetrafluoromethylphenyl)borate, tetrakis(tolyl)borate, tetrakis(xylyl)borate, (triphenyl-pentafluorophenyl)borate, [tris(pentafluorophenyl)phenyl]borate, and undecahydro-7,8-dicarboundecaborate.

Specific examples of the cation may include, but are not limited to, a carbonium cation, an oxonium cation, an ammonium cation, a phosphonium cation, a cycloheptatrienyl cation, and a ferrocenium cation containing a transition metal. The carbonium cation includes tri-substituted carbonium cations such as triphenylcarbonium cations and tri(substituted phenyl)carbonium cations. More specific examples of the tri(substituted phenyl)carbonium cations include tri(tolyl)carbonium cation. Specific examples of the ammonium cation may include, but are not limited to: trialkylammonium cations such as a trimethylammonium cation, a triethylammonium cation, a tripropylammonium cation, and a tributylammonium cation; N,N-dialkylanilinium cations such as a N,N-dimethylanilinium cation, a N,N-diethylanilinium cation, and a N,N-2,4,6-pentamethylanilinium cation; and dialkylammonium cations such as a diisopropylammonium cation and a dicyclohexylammonium cation. Specific examples of the phosphonium cation may include, but are not limited to, triaryl cations such as a triphenylphosphonium cation, a tris(tolyl)phosphonium cation, and a tris(xylyl)phosphonium cation.

According to the catalyst composition of the present invention, the organoboron compound is preferably N,N-dimethylanilinium tetrakis(pentafluorophenyl)borate and/or trityl tetrakis(pentafluorophenyl)borate.

According to the catalyst composition of the present invention, the organoaluminum compound and the organoboron compound which are used as the cocatalyst may be used alone or in combination.

In a preferred embodiment, the cocatalyst is the organoaluminum compound and the organoboron compound. In this preferred embodiment, the cocatalyst is more preferably triisobutylaluminum and N,N-dimethylanilinium tetrakis(pentafluorophenyl)borate. In this preferred embodiment, a molar ratio of the organoaluminum compound to the organoboron compound in the cocatalyst may be 1:0.01-100, preferably 1:0.1-90, more preferably 1:0.5-60, the organoaluminum compound being in terms of an aluminum element and the organoboron compound being in terms of a boron element. In this preferred embodiment, the amount of the cocatalyst used can be conventionally selected. When the cocatalyst contains the organoboron compound, a molar ratio of the metallocene complex to the organoboron compound is preferably 1:0.1-10, preferably 1:0.5-5.

According to a fourth aspect of the present invention, the present invention provides an olefin polymerization method, comprising contacting at least one olefin with components in a catalyst composition under olefin polymerization conditions, the catalyst composition being the catalyst composition according to the third aspect of the present invention.

The olefin polymerization method according to the present invention is particularly suitable as a copolymerization reaction of ethylene and a conjugated diene. According to the olefin polymerization method of the present invention, in a preferred embodiment, the olefin is a conjugated diene. In another preferred embodiment, the olefin is ethylene and a conjugated diene.

The conjugated diene refers to a compound containing a conjugated double bond in a molecular structure. The conjugated diene may be one or two or more selected from the group consisting of compounds represented by a formula VI,

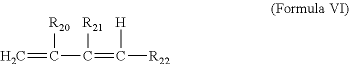

in the formula VI, R₂₀, R₂₁ and R₂₂ are the same or different, and are each selected from hydrogen and C₁-C₅ linear or branched alkyl.

According to the olefin polymerization method of the present invention, specific examples of the conjugated diene may include, but are not limited to, butadiene and/or isoprene. Preferably, the conjugated diene is butadiene.

According to the olefin polymerization method of the present invention, the amount of the metallocene complex used in the catalyst composition is preferably 0.1-1000 mol relative to 1 mol of the conjugated diene.

According to the olefin polymerization method of the present invention, the contacting may be performed at a temperature of −100° C. to 150° C., preferably at a temperature of 10° C.-50° C.

According to a fifth aspect of the present invention, the present invention provides an olefin polymer prepared by the method according to the fourth aspect of the present invention.

In a preferred embodiment, the olefin polymer contains an ethylene structural unit derived from ethylene and a conjugated diene structural unit derived from a conjugated diene. In this preferred embodiment, the ethylene structural unit may be present in an amount of 80 mol % or less, preferably 5-70 mol %, more preferably 10-60 mol %, based on the total amount of the olefin polymer. In this preferred embodiment, the content of a cis-1,4-structural unit in the structural unit derived from the conjugated diene is preferably 85 mol % or more, more preferably 90 mol % or more, further preferably 95 mol % or more, still further preferably 98 mol % or more. In this preferred embodiment, the conjugated diene is preferably butadiene. In the present invention, a cis-structural unit refers to a structural unit with a cis configuration in the conjugated diene structural unit, and the cis-1,4-structural unit refers to a structural unit in which a conjugated diene is formed by 1,4-polymerization and has a cis configuration.

The present invention is described below in detail with reference to examples, but the scope of the present invention is not limited thereby.

In the following Examples and Comparative Examples, the molecular weight and molecular weight distribution index (M_{w}/Mₙ) of the polymers were determined by using a 1260 Infinity II high-temperature gel permeation chromatograph manufactured by Agilent using chromatographic columns of two MIXD-B columns (300×7.5 mm) and one Guard column (50×7.5 mm). A mobile phase is trichlorobenzene and a flow rate is 1 mL/min; the sample solution concentration is 1 mg/mL and an injection volume is 200 μL; the test temperature is 150° C.; and monodisperse polystyrene is used as a standard sample.

In the following Examples and Comparative Examples, nuclear magnetic resonance spectroscopy was performed by using a 400 MHz nuclear magnetic resonance spectrometer commercially available from Bruker Corporation, polybutadiene was tested at room temperature by using deuterated chloroform as a solvent and tetramethylsilane (TMS) as an internal standard, and an ethylene-butadiene copolymer was tested at a temperature of 100° C. by using deuterated tetrachloroethane as a solvent. The content of a cis-1,4 structural unit in a butadiene structural unit is calculated from a ¹³C NMR spectrum of the polymer, peaks at 26.5-27.5 ppm correspond to carbon atoms in the cis-1,4 structural unit, and peaks at 26.5-27.5 ppm and 31.5-32.5 ppm correspond to carbon atoms in the butadiene structural unit; the content of an ethylene structural unit in the copolymer is calculated from a ¹³C NMR spectrum, and peaks at 28.5-30.0 ppm correspond to carbon atoms in the ethylene structural unit, and peaks at 26.5-27.5 ppm and 31.5-32.5 ppm correspond to carbon atoms in the butadiene structural unit. Wherein a cis-structural unit refers to a structural unit with a cis configuration and the cis-1,4-structural unit refers to a structural unit in which butadiene is formed by 1,4-polymerization and has a cis configuration.

In the following Examples and Comparative Examples, a calculation formula for monomer conversion is:

Monomer conversion (%)=mass of a polymer obtained/mass of monomers added×100%.

Preparation Examples 1-4 were used to prepare the metallocene complex according to the present invention.

### Preparation Example 1

### Synthesis of bis(2-methyl-3,5-diphenyl-6-hydro-cyclopentadienothiophene)gadolinium bis(trimethylsilylamide) (a Complex Shown in a Formula II)

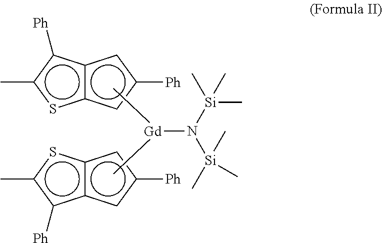

To a 40 mL solution of GdCl₃ (0.791 g, 3 mmol) in THE was slowly added dropwise a 20 mL solution of a lithium salt (1.819 g, 6.2 mmol) synthesized from 2-methyl-3,5-diphenyl-6-hydro-cyclopentadienothiophene and n-butyllithium in tetrahydrofuran (THF) under a nitrogen atmosphere. Then, the mixture was stirred at a temperature of 65° C. for 6 h. Thereafter, under reduced pressure, THE was distilled off and 50 mL of toluene was added. Then, 20 mL of a toluene solution of KN(SiMe₃)₂ (0.519 g, 2.6 mmol) was slowly added dropwise to the mixture, followed by stirring at room temperature (25° C.) for 12 h. Then, toluene was distilled off under reduced pressure, 100 mL of hexane was added, and a precipitate was removed by filtration. Thereafter, hexane was distilled off under reduced pressure to give a pale yellow solid target product (1.336 g, yield: 50%). The product was analyzed by elemental analysis and the obtained elemental analysis result was as follows: C 61.91; H 5.42.

### Preparation Example 2

### Synthesis of bis(2,5-dimethyl-3-phenyl-6-hydro-cyclopentadienothiophene)scandium bis(dimethylsilylamide) (a Complex Shown in a Formula III)

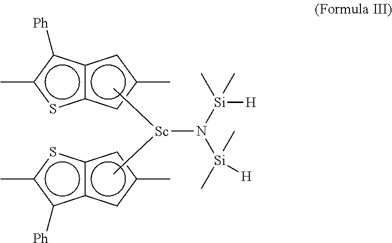

A metallocene complex was prepared by the same method as that in Preparation example 1 except that GdCl₃ in Preparation example 1 was replaced by ScCl₃, 2-methyl-3,5-diphenyl-6-hydro-cyclopentadienothiophene in Preparation example 1 was replaced by 2,5-dimethyl-3-phenyl-6-hydro-cyclopentadienothiophene, and KN(SiMe₃)₂ in Preparation example 1 was replaced by KN(SiMe₂H)₂ to give a pale yellow solid target product (1.183 g, yield: 63%). The product was analyzed by elemental analysis and the obtained elemental analysis result was as follows: C 65.91; H 6.76.

### Preparation Example 3

### Synthesis of bis(2-methyl-3-phenyl-5-isopropyl-6-hydro-cyclopentadienothiophene)gadolinium bis(trimethylsilylamide) (a Complex Shown in a Formula IV)

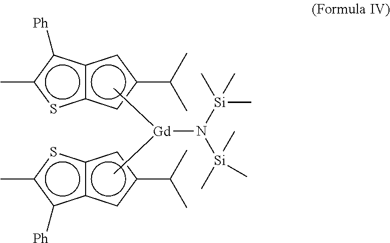

A metallocene complex was prepared by the same method as that in Preparation example 1 except that 2-methyl-3,5-diphenyl-6-hydro-cyclopentadienothiophene in Preparation example 1 was replaced by 2-methyl-3-phenyl-5-isopropyl-6-hydro-cyclopentadienothiophene to give a white solid target product (1.357 g, yield: 55%). The product was analyzed by elemental analysis and the obtained elemental analysis result was as follows: C 58.28; H 6.36.

### Preparation Example 4

### Synthesis of bis(2,5-dimethyl-3-phenyl-4-trimethylsilyl-6-hydro-cyclopentadienothiophene)gadolinium bis(trimethylsilylamide) (a Complex Shown in a Formula V)

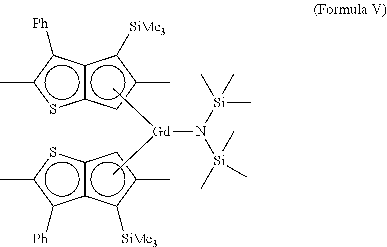

A metallocene complex was prepared by the same method as that in Preparation example 1 except that 2-methyl-3,5-diphenyl-6-hydro-cyclopentadienothiophene in Preparation example 1 was replaced by 2,5-dimethyl-3-phenyl-4-trimethylsilyl-6-hydro-cyclopentadienothiophene to give a white solid target product (1.232 g, yield: 45%). The product was analyzed by elemental analysis and the obtained elemental analysis result was as follows: C 55.27; H 6.63.

### Comparative Preparation Example 1

A complex VI was synthesized according to the method described in the literature, Dalton Trans., 2008, 2531-2533.

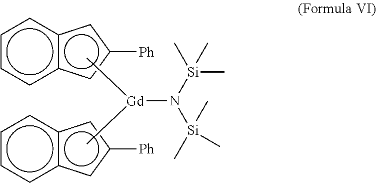

### Comparative Preparation Example 2

A complex VII was synthesized according to the method described in the literature, Angew. Chem. Int. Ed., 2017 (56), 6975-6979.

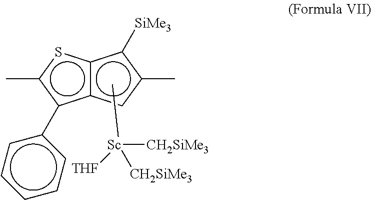

Examples 1-10 serve to illustrate the catalyst composition, the olefin polymerization method, and the olefin polymer according to the present invention.

### Example 1

In a glovebox under the protection of an argon atmosphere, 4.46 mg of the complex shown in the formula II and 4.00 mg of N,N-dimethylanilinium tetrakis(pentafluorophenyl)borate were dissolved in 3.6 mL of toluene in a glass vial, and 0.1 mL of a 1M solution of triisobutylaluminum in hexane was added. After sufficient dissolution, 3.5 mL of a toluene solution of butadiene (containing 0.54 g of butadiene) was added. Polymerization was performed at room temperature (25° C.) for 1 h. After completion of the polymerization, a small amount of methanol containing hydrochloric acid was added to terminate the reaction. The obtained product was poured into a large amount of ethanol, and a polymer was separated out and washed with ethanol. The washed polymer was dried in a vacuum oven until the weight was no longer reduced, thus obtaining polybutadiene. The monomer conversion is determined to be 100% by calculation, and it is determined that the polymer has a number average molecular weight (Mₙ) of 112000 and a molecular weight distribution index (M_{w}/Mₙ) of 1.2 by gel permeation chromatography (GPC). It is determined that the molar content of a cis-1,4-structural unit in the obtained polybutadiene is greater than 99% by the nuclear magnetic resonance spectroscopy.

### Example 2

In a glovebox under the protection of an argon atmosphere, 30.34 mg of the complex shown in the formula II and 27.24 mg of N,N-dimethylanilinium tetrakis(pentafluorophenyl)borate were dissolved in 8 mL of toluene in a glass vial to obtain a catalyst solution. 2 mL of a 1M solution of triisobutylaluminum in hexane and 7 mL of toluene were added into another glass vial to obtain a triisobutylaluminum solution. 120 g of toluene, the triisobutylaluminum solution, and 14 g of butadiene were sequentially added into a 500 mL autoclave. Then 0.8 MPa of ethylene was introduced, and after saturation, the catalyst solution was added. Polymerization was performed at 40° C. for 60 min. After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 14.6 g of a copolymer. It is determined that the copolymer has a number average molecular weight (Mₙ) of 105000 and a molecular weight distribution index (M_{w}/Mₙ) of 1.6 by gel permeation chromatography (GPC). By the nuclear magnetic resonance spectroscopy, it is determined that the molar content of a butadiene structural unit derived from butadiene in the copolymer is 86.2%; and the molar content of a cis-1,4-structural unit is 95.2% based on the total amount of the butadiene structural unit.

### Example 3

In a glovebox under the protection of an argon atmosphere, 28.03 mg of the complex shown in the formula III and 31.36 mg of trityl tetrakis(pentafluorophenyl)borate were dissolved in 8 mL of toluene in a glass vial to obtain a catalyst solution. 2 mL of a 1M solution of triisobutylaluminum in hexane and 7 mL of toluene were added into another glass vial to obtain a triisobutylaluminum solution. 120 g of toluene, the triisobutylaluminum solution, and 14 g of butadiene were sequentially added into a 500 mL autoclave. Then 0.8 MPa of ethylene was introduced, and after saturation, the catalyst solution was added. Polymerization was performed at room temperature (25° C.) for 180 min.

After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 13.2 g of a copolymer. It is determined that the copolymer has a number average molecular weight (Mₙ) of 131000 and a molecular weight distribution index (M_{w}/Mₙ) of 3.7 by gel permeation chromatography (GPC). By the nuclear magnetic resonance spectroscopy, it is determined that the molar content of a butadiene structural unit derived from butadiene in the copolymer is 65.2%; and the molar content of a cis-1,4-structural unit is 90.5% based on the total amount of the butadiene structural unit.

### Example 4

In a glovebox under the protection of an argon atmosphere, 4.12 mg of the complex shown in the formula IV and 4.00 mg of N,N-dimethylanilinium tetrakis(pentafluorophenyl)borate were dissolved in 3.6 mL of toluene in a glass vial, and 0.1 mL of a 1M solution of triisobutylaluminum in hexane was added. After sufficient dissolution, 3.5 mL of a toluene solution of butadiene (containing 0.54 g of butadiene) was added. Polymerization was performed at room temperature (25° C.) for 2 h. After completion of the polymerization, a small amount of methanol containing hydrochloric acid (0.2‰ by weight, hydrochloric acid being in terms of HCl) was added to terminate the reaction. The obtained product was poured into a large amount of ethanol, and a polymer was separated out and washed with ethanol. The washed polymer was dried in a vacuum oven until the weight was no longer reduced, thus obtaining polybutadiene. The monomer conversion is determined to be 100% by calculation, and it is determined that the polymer has a number average molecular weight (Mₙ) of 101000 and a molecular weight distribution index (M_{w}/Mₙ) of 1.4 by gel permeation chromatography (GPC). It is determined that the molar content of a cis-1,4-structural unit in the obtained polybutadiene is greater than 99% by the nuclear magnetic resonance spectroscopy.

### Example 5

In a glovebox under the protection of an argon atmosphere, 31.03 mg of the complex shown in the formula V and 27.24 mg of N,N-dimethylanilinium tetrakis(pentafluorophenyl)borate were dissolved in 8 mL of toluene in a glass vial to obtain a catalyst solution. 2 mL of a 1M solution of diisobutylaluminum hydride in hexane and 7 mL of toluene were added into another glass vial to obtain a diisobutylaluminum hydride solution. 120 g of toluene, the diisobutylaluminum hydride solution, and 14 g of butadiene were sequentially added into a 500 mL autoclave. Then 0.8 MPa of ethylene was introduced, and after saturation, the catalyst solution was added. Polymerization was performed at room temperature (25° C.) for 180 min. After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 12.1 g of a copolymer. It is determined that the copolymer has a number average molecular weight (Mₙ) of 288000 and a molecular weight distribution index (M_{w}/Mₙ) of 2.4 by gel permeation chromatography (GPC). By the nuclear magnetic resonance spectroscopy, it is determined that the molar content of a butadiene structural unit derived from butadiene in the copolymer is 78.3%; and the molar content of a cis-1,4-structural unit is greater than 99% based on the total amount of the butadiene structural unit.

### Example 6

In a glovebox under the protection of an argon atmosphere, 28.03 mg of the complex shown in the formula III and 27.24 mg of N,N-dimethylanilinium tetrakis(pentafluorophenyl)borate were dissolved in 8 mL of toluene in a glass vial to obtain a catalyst solution. 2 mL of a 1M solution of triisobutylaluminum in hexane and 7 mL of toluene were added into another glass vial to obtain a triisobutylaluminum solution. 120 g of toluene, the triisobutylaluminum solution and 14 g of butadiene were sequentially added into a 500 mL autoclave. Then 1.2 MPa of ethylene was introduced, and after saturation, the catalyst solution was added. Polymerization was performed at 40° C. for 60 min. After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 6.5 g of a copolymer. It is determined that the copolymer has a number average molecular weight (Mₙ) of 123000 and a molecular weight distribution index (M_{w}/Mₙ) of 3.1 by gel permeation chromatography (GPC). By the nuclear magnetic resonance spectroscopy, it is determined that the molar content of a butadiene structural unit derived from butadiene in the copolymer is 48.4%; and the molar content of a cis-1,4-structural unit is 90.2% based on the total amount of the butadiene structural unit.

### Example 7

In a glovebox under the protection of an argon atmosphere, 30.34 mg of the complex shown in the formula II and 27.24 mg of N,N-dimethylanilinium tetrakis(pentafluorophenyl)borate were dissolved in 8 mL of toluene in a glass vial to obtain a catalyst solution. 2 mL of a 1M solution of triisobutylaluminum in hexane and 7 mL of toluene were added into another glass vial to obtain a triisobutylaluminum solution. 120 g of toluene, the triisobutylaluminum solution, and 14 g of butadiene were sequentially added into a 500 mL autoclave. Then 0.8 MPa of ethylene was introduced, and after saturation, the catalyst solution was added. Polymerization was performed at room temperature (25° C.) for 180 min. After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 5.14 g of a copolymer. It is determined that the copolymer has a number average molecular weight (Mₙ) of 83000 and a molecular weight distribution index (M_{w}/Mₙ) of 2.7 by gel permeation chromatography (GPC). By the nuclear magnetic resonance spectroscopy, it is determined that the molar content of a butadiene structural unit derived from butadiene in the copolymer is 85.6%; and the molar content of a cis-1,4-structural unit is 98.5% based on the total amount of the butadiene structural unit.

### Comparative Example 1

The same method as that in Example 2 was used, except that the metallocene complex VI prepared in Comparative Preparation Example 1 was used instead of the complex shown in the formula II, thus obtaining 13.8 g of a copolymer. It is determined that the copolymer has a number average molecular weight (Mₙ) of 96000 and a molecular weight distribution index (M_{w}/Mₙ) of 1.7 by gel permeation chromatography (GPC). By the nuclear magnetic resonance spectroscopy, it is determined that the molar content of a butadiene structural unit derived from butadiene in the copolymer is 82%; and the molar content of a cis-1,4-structural unit is 91.3% based on the total amount of the butadiene structural unit.

### Example 8

In a glovebox under the protection of an argon atmosphere, 22.24 mg of the complex shown in the formula III and 27.24 mg of N,N-dimethylanilinium tetrakis(pentafluorophenyl)borate were dissolved in 8 mL of toluene in a glass vial to obtain a catalyst solution. 2 mL of a 1M solution of triisobutylaluminum in hexane and 7 mL of toluene were added into another glass vial to obtain a triisobutylaluminum solution. 120 g of toluene, the triisobutylaluminum solution, and 14 g of butadiene were sequentially added into a 500 mL autoclave. Then 0.8 MPa of ethylene was introduced, and after saturation, the catalyst solution was added. Polymerization was performed at 40° C. for 60 min. After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 8.70 g of a copolymer. It is determined that the copolymer has a number average molecular weight (Mₙ) of 112000 and a molecular weight distribution index (M_{w}/Mₙ) of 2.5 by gel permeation chromatography (GPC). By the nuclear magnetic resonance spectroscopy, it is determined that the molar content of a butadiene structural unit derived from butadiene in the copolymer is 65.3%; and the molar content of a cis-1,4-structural unit is 88.4% based on the total amount of the butadiene structural unit.

### Comparative Example 2

In a glovebox under the protection of an argon atmosphere, 17.50 mg of the complex shown in the formula VII and 27.24 mg of N,N-dimethylanilinium tetrakis(pentafluorophenyl)borate were dissolved in 8 mL of toluene in a glass vial to obtain a catalyst solution. 2 mL of a 1M solution of triisobutylaluminum in hexane and 7 mL of toluene were added into another glass vial to obtain a triisobutylaluminum solution. 120 g of toluene, the triisobutylaluminum solution, and 14 g of butadiene were sequentially added into a 500 mL autoclave. Then 0.8 MPa of ethylene was introduced, and after saturation, the catalyst solution was added. The polymerization was performed at 40° C. for 60 min. After completion of the polymerization, the obtained product was poured into a large amount of ethanol with hydrochloric acid added (0.2‰ by weight, hydrochloric acid being in terms of HCl), and precipitated, and a copolymer was separated out by filtration and washed with ethanol. The washed copolymer was dried in a vacuum oven until the weight was no longer reduced, thus obtaining 4.81 g of a copolymer. It is determined that the copolymer has a number average molecular weight (Mₙ) of 105000 and a molecular weight distribution index (M_{w}/Mₙ) of 2.3 by gel permeation chromatography (GPC). By the nuclear magnetic resonance spectroscopy, it is determined that the molar content of a butadiene structural unit derived from butadiene in the copolymer is 71.5%; and the molar content of a cis-1,4-structural unit is 86.3% based on the total amount of the butadiene structural unit.

### Example 9

In a glovebox under the protection of an argon atmosphere, 4.12 mg of the complex shown in the formula III and 4.61 mg of trityl tetrakis(pentafluorophenyl)borate were dissolved in 3.6 mL of toluene in a glass vial, and 0.1 mL of a 1M solution of triisobutylaluminum in hexane was added. After sufficient dissolution, 3.5 mL of a toluene solution of butadiene (containing 0.54 g of butadiene) was added. Polymerization was performed at room temperature (25° C.) for 2 h. After completion of the polymerization, a small amount of methanol containing hydrochloric acid (0.2‰ by weight, hydrochloric acid being in terms of HCl) was added to terminate the reaction. The obtained product was poured into a large amount of ethanol, and a polymer was separated out and washed with ethanol. The washed polymer was dried in a vacuum oven until the weight was no longer reduced, thus obtaining polybutadiene. The monomer conversion is determined to be 100% by calculation, and it is determined that the polymer has a number average molecular weight (Mₙ) of 145000 and a molecular weight distribution index (M_{w}/Mₙ) of 1.4 by gel permeation chromatography (GPC). It is determined that the molar content of a cis-1,4-structural unit in the obtained polybutadiene is 91.5% by the nuclear magnetic resonance spectroscopy.

### Example 10

In a glovebox under the protection of an argon atmosphere, 4.56 mg of the complex shown in the formula V and 4.00 mg of N,N-dimethylanilinium tetrakis(pentafluorophenyl)borate were dissolved in 3.6 mL of toluene in a glass vial, and 0.1 mL of a 1M solution of triisobutylaluminum in hexane was added. After sufficient dissolution, 3.5 mL of a toluene solution of butadiene (containing 0.54 g of butadiene) was added. Polymerization was performed at room temperature (25° C.) for 2 h. After completion of the polymerization, a small amount of methanol containing hydrochloric acid (0.2‰ by weight, hydrochloric acid being in terms of HCl) was added to terminate the reaction. The obtained product was poured into a large amount of ethanol, and a polymer was separated out and washed with ethanol. The washed polymer was dried in a vacuum oven until the weight was no longer reduced, thus obtaining polybutadiene. The monomer conversion is determined to be 100% by calculation, and it is determined that the polymer has a number average molecular weight (Mₙ) of 125000 and a molecular weight distribution index (M_{w}/Mₙ) of 1.3 by gel permeation chromatography (GPC). It is determined that the molar content of a cis-1,4-structural unit in the obtained polybutadiene is greater than 99% as determined by the nuclear magnetic resonance spectroscopy.

### Comparative Example 3

In a glovebox under the protection of an argon atmosphere, 3.50 mg of the complex shown in the formula VI and 4.00 mg of N,N-dimethylanilinium tetrakis(pentafluorophenyl)borate were dissolved in 3.6 mL of toluene in a glass vial, and 0.1 mL of a 1M solution of triisobutylaluminum in hexane was added. After sufficient dissolution, 3.5 mL of a toluene solution of butadiene (containing 0.54 g of butadiene) was added. Polymerization was performed at room temperature (25° C.) for 2 h. After completion of the polymerization, a small amount of methanol containing hydrochloric acid (0.2‰ by weight, hydrochloric acid being in terms of HCl) was added to terminate the reaction. The obtained product was poured into a large amount of ethanol, and a polymer was separated out and washed with ethanol. The washed polymer was dried in a vacuum oven until the weight was no longer reduced, thus obtaining polybutadiene. The monomer conversion is 96.3%, and it is determined that the polymer has a number average molecular weight (Mₙ) of 125000 and a molecular weight distribution index (M_{w}/Mₙ) of 1.2 by gel permeation chromatography (GPC). It is determined that the molar content of a cis-1,4-structural unit in the obtained polybutadiene is greater than 99% by the nuclear magnetic resonance spectroscopy.

### Comparative Example 4

In a glovebox under the protection of an argon atmosphere, 2.93 mg of the complex shown in the formula VII and 4.61 mg of trityl tetrakis(pentafluorophenyl)borate were dissolved in 3.6 mL of toluene in a glass vial, and 0.1 mL of a 1M solution of triisobutylaluminum in hexane was added. After sufficient dissolution, 3.5 mL of a toluene solution of butadiene (containing 0.54 g of butadiene) was added. Polymerization was performed at room temperature (25° C.) for 2 h. After completion of the polymerization, a small amount of methanol containing hydrochloric acid (0.2‰ by weight, hydrochloric acid being in terms of HCl) was added to terminate the reaction. The obtained product was poured into a large amount of ethanol, and a polymer was separated out and washed with ethanol. The washed polymer was dried in a vacuum oven until the weight was no longer reduced, thus obtaining polybutadiene. The monomer conversion is determined to be 100% by calculation, and it is determined that the polymer has a number average molecular weight (Mₙ) of 123000 and a molecular weight distribution index (M_{w}/Mₙ) of 1.4 by gel permeation chromatography (GPC). It is determined that the molar content of a cis-1,4-structural unit in the obtained polybutadiene is 85.3% by the nuclear magnetic resonance spectroscopy.

The experimental results of Examples 1-10 confirm that the metallocene complex according to the present invention exhibits an increased catalytic activity and can achieve a high yield of polymers. The metallocene complex according to the present invention enables efficient and highly regioselective polymerization of conjugated dienes. When the metallocene complex according to the present invention is used for the copolymerization of ethylene and conjugated dienes, the copolymerization of ethylene-conjugated diene can be efficiently carried out, and the copolymerization composition of the copolymer can be effectively controlled.

By comparing Example 2 with Comparative Example 1, Example 8 with Comparative Example 2, and Example 1 with Comparative Examples 3 and 4, it can be seen that under the same conditions, the polymerization method of the present invention can prepare more copolymers, indicating that transition metal complexes used in the polymerization method of the present invention have higher catalytic activity, thereby achieving higher polymerization reaction efficiency.

Preferred embodiments of the present invention are described in detail above, but the present invention is not limited thereto. Within the scope of the technical idea of the present invention, many simple variations can be made to the technical solutions of the present invention, including the combination of the technical features in any other suitable manner, and these simple variations and combinations should also be regarded as disclosed in the present invention, and all fall within the protection scope of the present invention.

1. A metallocene complex, having a structure shown in a formula I, 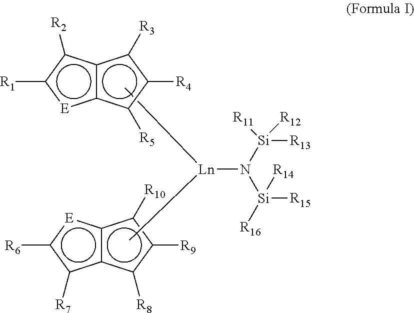
Wherein in the formula I, Ln is a lanthanide, scandium, or yttrium;
R₁, R₂, R₃, R₄, R₅, R₆, R₇, R₈, R₉, and R₁₀ are the same or different, and are each independently hydrogen, C₁-C₂₀ alkyl, C₆-C₃₀ aryl or —SiR₂₃R₂₄R₂₅, and R₂₃, R₂₄, and R₂₅ are the same or different, and are each independently hydrogen or C₁-C₂₀ alkyl;
R₁₁, R₁₂, R₁₃, R₁₄, R₁₅ and R₁₆ are the same or different, and are each independently hydrogen or C₁-C₅ alkyl;
E is O, S, or N—R₁₇, and R₁₇ is C₁-C₅ alkyl or C₆-C₁₂ aryl.

2. The metallocene complex according to claim 1, wherein in the formula I, R₁ and R₆ are each independently C₁-C₅ alkyl, R₂, R₄, R₇ and R₉ are each independently C₆-C₁₂ aryl, and R₃, R₅, R₈ and R₁₀ are all hydrogen;
preferably, R₁ and R₆ are methyl and R₂, R₄, R₇ and R₉ are phenyl.

3. The metallocene complex according to claim 1, wherein in the formula I, R₁, R₄, R₆ and R₉ are each independently C₁-C₂₀ alkyl, R₂ and R₇ are each independently C₆-C₃₀ aryl, and R₃, R₅, R₈ and R₁₀ are all hydrogen;
preferably, R₁, R₄, R₆ and R₉ are each independently C₁-C₅ alkyl, and R₂ and R₇ are each independently C₆-C₁₂ aryl;
more preferably, R₁, R₄, R₆ and R₉ are each independently methyl or isopropyl, and R₂ and R₇ are phenyl;
further preferably, R₁ and R₆ are methyl, R₄ and R₉ are methyl or isopropyl, and R₂ and R₇ are phenyl.

4. The metallocene complex according to claim 1, wherein in the formula I, R₁, R₄, R₆ and R₉ are each independently C₁-C₂₀ alkyl, R₂ and R₇ are each independently C₆-C₃₀ aryl, R₅ and R₁₀ are both hydrogen, R₃ and R₈ are each independently —SiR₂₃R₂₄R₂₅, and R₂₃, R₂₄ and R₂₅ are the same or different, and are each independently C₁-C₂₀ alkyl;
preferably, R₁, R₄, R₆ and R₉ are each independently C₁-C₅ alkyl, R₂ and R₇ are each independently C₆-C₁₂ aryl, R₃ and R₈ are each independently —SiR₂₃R₂₄R₂₅, R₂₃, R₂₄ and R₂₅ are the same or different, and are each independently hydrogen or C₁-C₅ alkyl, and at least one of R₂₃, R₂₄ and R₂₅ is C₁-C₅ alkyl;
more preferably, R₁, R₄, R₆ and R₉ are methyl, R₂ and R₇ are phenyl, R₃ and R₈ are each independently —SiR₂₃R₂₄R₂₅, and R₂₃, R₂₄ and R₂₅ are all methyl.

5. The metallocene complex according to claim 1, wherein in the formula I, Ln is scandium or gadolinium.

6. The metallocene complex according to claim 1, wherein the metallocene complex is a complex shown in a formula II, a formula III, a formula IV or a formula V,

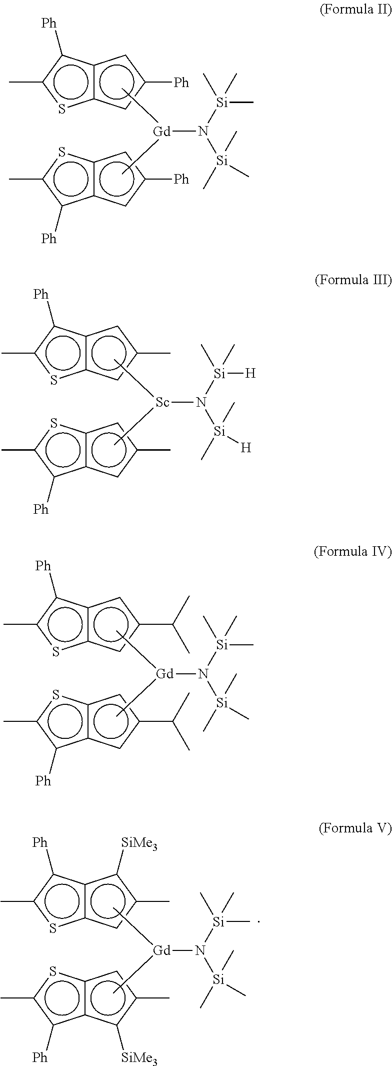

7. The metallocene complex according to claim 1, wherein the metallocene complex is prepared by a method; comprising the steps of:
Step 1, contacting a precursor compound with a heterocyclic compound in the presence of organolithium, wherein the heterocyclic compound is selected from the group consisting of compounds represented by a formula 2-2-1 and compounds represented by a formula 2-2-2, and
Step 2, contacting a mixture obtained in the step 1 with an amine represented by a formula 2-3, wherein
the precursor compound is selected from the group consisting of compounds represented by a formula 2-1,
LnX (Formula 2-1)
in the formula 2-1, Ln is a lanthanide, scandium, or yttrium,
X is a halogen atom, preferably chlorine; 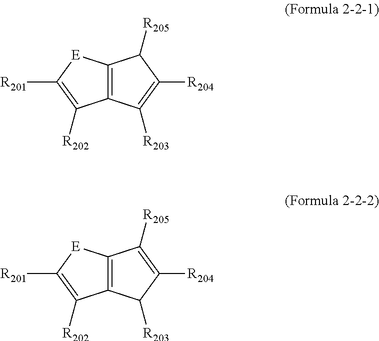
in the formula 2-2-1 and formula 2-2-2, R₂₀₁, R₂₀₂, R₂₀₃, R₂₀₄, and R₂₀₅ are the same or different, and are each independently hydrogen, C₁-C₂₀ alkyl, C₆-C₃₀ aryl or —SiR₂₃R₂₄R₂₅, and R₂₃, R₂₄, and R₂₅ are the same or different, and are each independently hydrogen or C₁-C₂₀ alkyl;
in the formula 2-2-1 and formula 2-2-2, E is O, S, or N—R₁₇, and R₁₇ is C₁-C₅ alkyl or C₆-C₁₂ aryl; 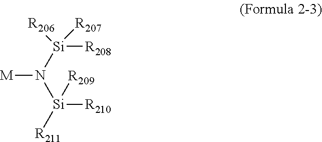
in the formula 2-3, R₂₀₆, R₂₀₇, R₂₀₈, R₂₀₉, R₂₁₀, and R₂₁₁ are the same or different, and are each independently hydrogen or C₁-C₅ alkyl,
M is an alkali metal atom, preferably potassium or sodium.

8. The metallocene complex according to claim 7, wherein the mixture obtained after the contacting in the step 1 is directly used in the step 2 without separation;
preferably, the contacting in the step 1 is performed in a first solvent, the contacting in the step 2 is performed in a second solvent, the first solvent and the second solvent are different, and the method comprises removing at least part of the first solvent from the mixture obtained after the contacting in the step 1 to obtain a mixture with at least part of the first solvent removed, and mixing the mixture with at least part of the first solvent removed with the second solvent;
preferably, the first solvent is one or two or more selected from the group consisting of tetrahydrofuran, diethyl ether, dioxane and hexane, and the second solvent is one or two or more selected from the group consisting of toluene, xylene and chlorobenzene.

9. The metallocene complex according to claim 7, wherein in the step 1, the organolithium is contacted with the heterocyclic compound represented by a formula 2-2 to form a lithium salt, and the lithium salt is contacted with the precursor compound.

10. The metallocene complex according to claim 7, wherein the contacting in the step 1 is performed at a temperature of 0-65° C. for 1-120 h;
the contacting in the step 2 is performed at a temperature of 0-30° C. for 1-48 h.

11. A catalyst composition, comprising a metallocene complex and a cocatalyst, the metallocene complex being the metallocene complex according to claim 1.

12. The catalyst composition according to claim 11, wherein the cocatalyst is an organoaluminum compound and/or an organoboron compound;
preferably, the organoaluminum compound is aluminoxane and/or a compound represented by a formula V, 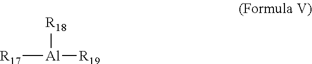
in the formula V, R₁₇, R₁₈, and R₁₉ are the same or different, and are each independently selected from hydrogen, C₁-C₁₀ alkyl, C₁-C₁₀ alkoxy, C₆-C₂₀ aryl, C₇-C₁₅ alkaryl, C₇-C₁₅ aralkyl, and a hydrogen atom, and R₁₇, R₁₈, and R₁₉ are not simultaneously a hydrogen atom;
the organoaluminum compound is preferably triisobutylaluminum and/or diisobutylaluminum hydride;
preferably, the organoboron compound is an organoborate, preferably N,N-dimethylanilinium tetrakis(pentafluorophenyl)borate and/or trityl tetrakis(pentafluorophenyl)borate.

13. The catalyst composition according to claim 11, wherein the cocatalyst is an organoaluminum compound and an organoboron compound, the organoaluminum compound is preferably triisobutylaluminum and/or diisobutylaluminum hydride, and the organoboron compound is preferably N,N-dimethylanilinium tetrakis(pentafluorophenyl)borate and/or trityl tetrakis(pentafluorophenyl)borate;
preferably, a molar ratio of the organoaluminum compound to the organoboron compound in the cocatalyst is 1:0.01-100, preferably 1:0.1-90, more preferably 1:0.5-60, the organoaluminum compound being in terms of an aluminum element and the organoboron compound being in terms of a boron element; and
preferably, a molar ratio of the metallocene complex to the organoboron compound is 1:0.1-10, preferably 1:0.5-5.

14. An olefin polymerization method, comprising contacting at least one olefin with components in a catalyst composition under olefin polymerization conditions, the catalyst composition being the catalyst composition according to claim 11.

15. The method according to claim 14, wherein the olefin is a conjugated diene or the olefin is ethylene and a conjugated diene;
preferably, the conjugated diene is butadiene and/or isoprene.

16. (canceled)
